(19) United States
(12) Patent Application Publication
(10) Pub. No.: US 2022/0407353 A1
(43) Pub. Date: Dec. 22, 2022

(54) WIRELESS CHARGER

(71) Applicant: Cheng Uei Precision Industry Co., LTD., New Taipei City (TW)

(72) Inventors: YUAN-YU HWANG, New Taipei City (TW); XIAO-KANG YANG, Dong-Guan City (CN); QIN-XIANG LIU, Dong-Guan City (CN)

(21) Appl. No.: 17/733,984

(22) Filed: Apr. 29, 2022

(30) Foreign Application Priority Data
Jun. 21, 2021 (CN) 202121381787.2

(51) Int. Cl. H02J 50/00; H02J 7/00; H02J 50/90

(52) U.S. Cl. CPC H02J 50/005; H02J 7/0044; H02J 50/90

(57) ABSTRACT

A wireless charger includes a housing which is a circular plate shape, a wireless charging module and a holder. An inside of the housing has an internal space. A front of a lower portion of a peripheral surface of the housing is recessed inward to form a holding slot. Two sides of the housing define two blind holes. The holding slot is connected with the two blind holes. The wireless charging module is assembled in the internal space. The holder is placed in the holding slot. The holder is pivotally located in the housing. The holder is rotatable around a bottom surface of the housing. The holder has a frame, and two pivot pins protruded towards each other from two ends of the frame. The two pivot pins are assembled to the two blind holes.

### CROSS-REFERENCE TO RELATED APPLICATION

The present application is based on, and claims priority from, China Patent Application No. 202121381787.2, filed Jun. 21, 2021, the disclosure of which is hereby incorporated by reference herein in its entirety.

### BACKGROUND OF THE INVENTION

### 1. Field of the Invention

The present invention generally relates to a wireless charger, and more particularly to a wireless charger which has a foldable holder.

### 2. The Related Art

With the development and maturity of wireless charging technology, the wireless charging technology is gradually applied to electronic devices around us, such as cell phones and tablet computers. Comparing to a traditional charging way which is generally a plug-and-jack charging way, the wireless charging technology improves a charging convenience.

Currently, a wireless charger is generally positioned on a displaying table statically, when an electronic product is to be charged, the electronic product is attached to the wireless charger for charging. However, the wireless charger is usually designed to be just positioned levelly, when the wireless charger charges the electronic product which is a smart phone, the user has a lot of inconveniences in using the smart phone, so a poor viewing angle, an inconvenient operation and other problems of the smart phone are caused.

Therefore, it is especially important to provide a wireless charger which has a foldable holder.

### SUMMARY OF THE INVENTION

An object of the present invention is to provide a wireless charger which has a foldable holder. The wireless charger includes a housing which is a circular plate shape, a wireless charging module and a holder. An inside of the housing has an internal space. A front of a lower portion of a peripheral surface of the housing is recessed inward to form a holding slot. The holding slot penetrates through a bottom surface of the housing. Two sides of the housing define two blind holes. The two blind holes are symmetrical to each other with respect to a center of the housing. The two blind holes penetrate through two sides of the peripheral surface of the housing and two outer portions of two tail ends of an inner wall of the holding slot. The two blind holes are disposed at two opposite ends of a diameter of the circular plate-shaped housing. The holding slot is disposed around an outer rim of the housing. The holding slot is connected with the two blind holes. The holding slot is a semicircle arc shape. The wireless charging module is assembled in the internal space. The holder is placed in the holding slot. The holder is pivotally located in the housing. The holder is rotatable around the bottom surface of the housing. The holder has a C-shaped frame, and two pivot pins protruded towards each other from two ends of the frame. The two pivot pins are matched with the two blind holes. The two pivot pins are assembled to the two blind holes. The two pivot pins are connected to the two blind holes.

Another object of the present invention is to provide a wireless charger. The wireless charger includes a housing which is a circular plate shape, a wireless charging module, a plurality of magnetic components and a holder. An inside of the housing has an internal space. A front of a lower portion of a peripheral surface of the housing is recessed inward to form a holding slot. The holding slot penetrates through a bottom surface of the housing. Two sides of the housing define two blind holes. The two blind holes are symmetrical to each other with respect to a center of the housing. The two blind holes penetrate through two sides of the peripheral surface of the housing and two outer portions of two tail ends of an inner wall of the holding slot. The holding slot is connected with the two blind holes. The holding slot is a semicircle arc shape. The wireless charging module is assembled in the internal space. The plurality of magnetic components are arranged around a periphery of the internal space. The holder is pivotally mounted in the holding slot of the housing. The holder is rotatable around the bottom surface of the housing. The holder is foldable. The holder has a frame, and two pivot pins protruded towards each other from two ends of the frame. The frame is the semicircle arc shape. The two pivot pins are assembled to the two blind holes. When the holder is rotated to make that an angle between the holder and the bottom surface of the housing is ninety degrees, and rears of the two ends of the frame of the holder abut against rear surfaces of the two tail ends of the inner wall of the holding slot, so that the holder is secured, then the housing and the secured holder are positioned on a plane, and the housing is inclined to the plane. When the holder is folded into the holding slot, the holder is located in the holding slot.

Another object of the present invention is to provide a wireless charger. The wireless charger includes a housing which is a circular plate shape, a lid, a wireless charging module, a plurality of magnetic components, a holder, a cable and a plug. An inside of the housing has an internal space. The internal space penetrates through a top of the housing. A front of a lower portion of a peripheral surface of the housing is recessed inward to form a holding slot. The holding slot penetrates through a bottom surface of the housing. Two sides of the housing define two blind holes. The two blind holes are symmetrical to each other with respect to a center of the housing. The two blind holes penetrate through two sides of the peripheral surface of the housing and two outer portions of two tail ends of an inner wall of the holding slot. The holding slot is connected with the two blind holes. The holding slot is a semicircle arc shape. A middle of a lower portion of the inner wall of the holding slot protrudes frontward to form at least one limiting block. The lid is covered to the top of the housing to enclose the internal space between the housing and the lid. The wireless charging module is assembled in the internal space. The plurality of magnetic components are arranged around a periphery of the internal space. The holder is pivotally mounted in the holding slot of the housing. The holder is rotatable around the bottom surface of the housing. The holder is foldable. The holder has a frame, and two pivot pins protruded towards each other from two ends of the frame. The frame is the semicircle arc shape. The frame is pivotally located in the holding slot of the housing. The two pivot pins are assembled to the two blind holes. A front end of the cable is connected to the wireless charging module. The plug is connected to a rear end of the cable. When the holder is rotated to make that an angle between the holder and the bottom surface of the housing is ninety degrees, and rears of the two ends of the frame of the holder abut against rear surfaces of the two tail ends of the inner wall of the holding slot, so that the holder is secured, then the housing and the secured holder are positioned on a plane, and the housing is inclined to the plane. When the holder is folded into the holding slot, the at least one limiting block blocks a bottom of the frame of the holder to make the frame of the holder fastened in the holding slot.

As described above, the holder of the wireless charger is rotatable around the bottom surface of the housing, when the holder is rotated to make that the angle between the holder and the bottom surface of the housing is ninety degrees, and the rears of the two ends of the frame of the holder abut against two third connection surfaces, so that the holder is secured, then the housing and the secured holder are positioned on the plane, and the housing is inclined to the plane, when the holder is foldable, the holder is folded into the holding slot, so that when the wireless charger charges a smart phone, a user uses the smart phone conveniently. As a result, the user has a better viewing angle, a convenient operation and other conveniences.

### BRIEF DESCRIPTION OF THE DRAWINGS

The present invention will be apparent to those skilled in the art by reading the following description, with reference to the attached drawings, in which:

FIG. 1 is a perspective view of a wireless charger in accordance with the present invention;

FIG. 2 is an enlarged view of an encircled portion II of the wireless charger of FIG. 1;

FIG. 3 is an exploded view of the wireless charger according to the present invention;

FIG. 4 is a perspective view of a housing of the wireless charger of the present invention; and

FIG. 5 is a perspective view of the wireless charger, wherein an unfolded holder supports the housing of the wireless charger according to the present invention.

### DETAILED DESCRIPTION OF THE PREFERRED EMBODIMENT

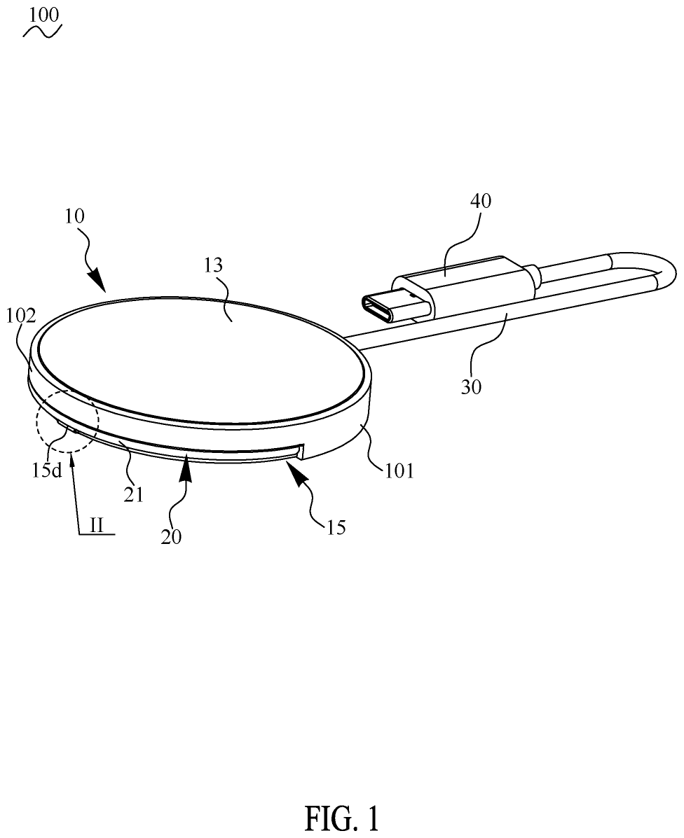

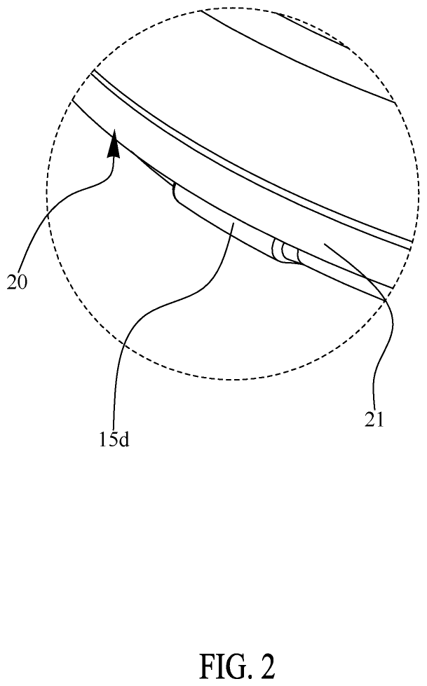

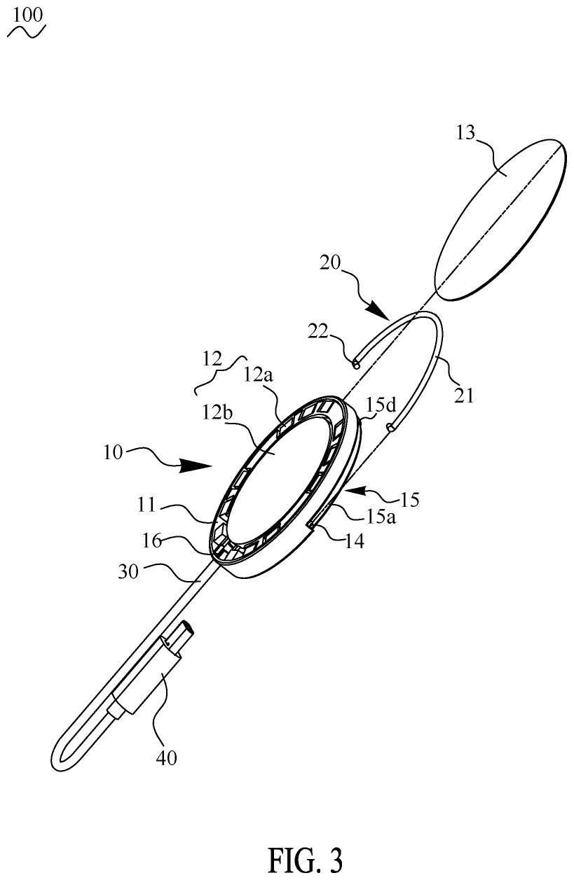

Referring to FIG. 1 to FIG. 3, a wireless charger 100 in accordance with the present invention is shown. The wireless charger 100 includes a housing 10 and a wireless charging module 12. The housing 10 is a circular plate shape.

The housing 10 has a base portion 101, an internal space 11, and a lid 13 mounted to a top of the base portion 101. An inside of the housing 10 has the internal space 11. The internal space 11 penetrates through a top of the housing 10. The base portion 101 is a hollow plate shape. An inside of the base portion 101 defines the internal space 11. The internal space 11 penetrates through a top surface of the base portion 101. The lid 13 is covered to the top of the housing 10 to enclose the internal space 11 between the housing 10 and the lid 13. The lid 13 is covered to the top of the base portion 101. The base portion 101 and the lid 13 enclose the internal space 11 between the base portion 101 of the housing 10 and the lid 13. The wireless charging module 12 is assembled in the internal space 11.

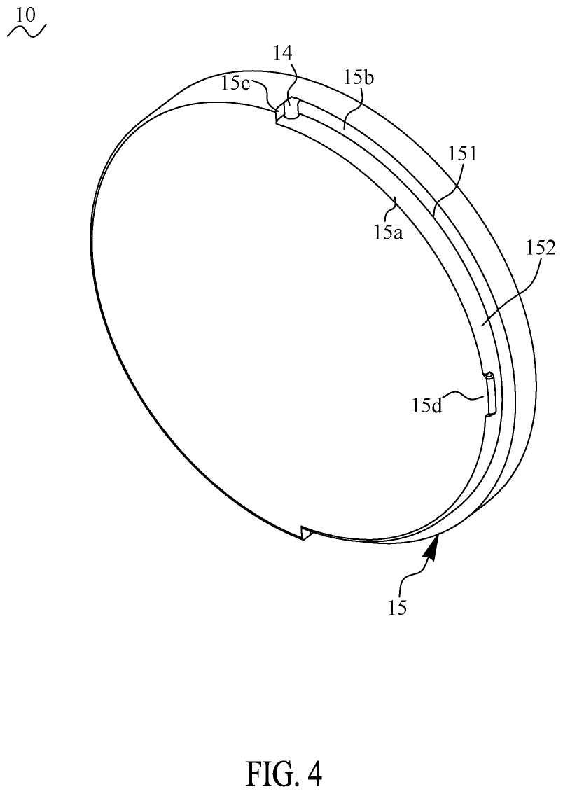

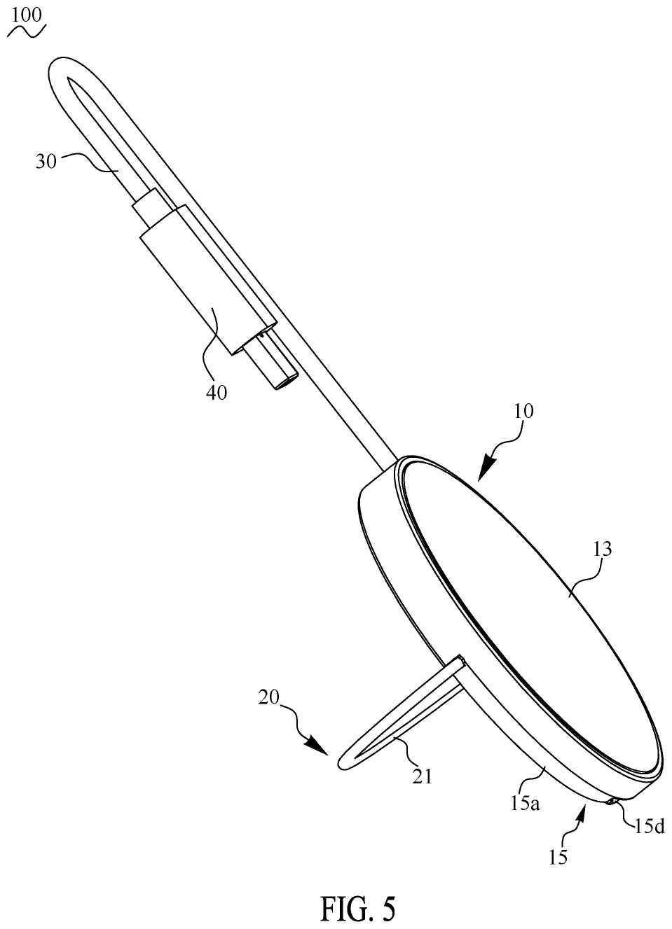

Referring to FIG. 1 to FIG. 5, when the wireless charger 100 charges a smart phone (not shown), in order to position the wireless charger 100 inclined to a plane, and a user uses the smart phone at the time of charging the smart phone, the wireless charger 100 includes a holder 20. The holder 20 is pivotally connected to a surface of the housing 10. A front of a lower portion of a peripheral surface 102 of the housing 10 is recessed inward to form a holding slot 15. The holding slot 15 penetrates through a bottom surface of the housing 10. A middle of the holding slot 15 is arched frontward. The holding slot 15 is a semicircle arc shape. Two sides of the housing 10 define two blind holes 14. The two blind holes 14 are symmetrical to each other with respect to a center of the housing 10. The two blind holes 14 penetrate through two sides of the peripheral surface 102 of the housing 10 and two outer portions of two tail ends of an inner wall 151 of the holding slot 15. The two blind holes 14 are disposed at two opposite ends of a diameter of the circular plate-shaped housing 10. The holding slot 15 is disposed around an outer rim of the housing 10. The holding slot 15 is connected with the two blind holes 14.

The holder 20 is the semicircle arc shape. The holder 20 is placed in the holding slot 15. The holder 20 is pivotally located in the two blind holes 14 of the housing 10. The holder 20 is pivotally mounted in the holding slot 15 of the housing 10. The holder 20 is pivotally located in the holding slot 15 of the housing 10. The holder 20 is rotatable around the bottom surface of the housing 10. The holder 20 is foldable. The inner wall 151 of the holding slot 15 has a first connection surface 15a, a second connection surface 15b and two third connection surfaces 15c. The first connection surface 15a is a semicircle shape. The second connection surface 15b is another semicircle shape. The first connection surface 15a is disposed along a vertical direction. The second connection surface 15b is disposed along a horizontal direction. The second connection surface 15b extends towards the outer rim of the housing 10. The two third connection surfaces 15c are rectangular shapes. The two third connection surfaces 15c are disposed along the vertical direction.

The first connection surface 15a is connected to the bottom surface of the housing 10 along the vertical direction. The first connection surface 15a extends towards a top surface of the housing 10 along the vertical direction. The second connection surface 15b is connected to a top edge of the first connection surface 15a along the horizontal direction. The first connection surface 15a is connected to an inner edge of the second connection surface 15b along the vertical direction. The holding slot 15 is a C shape. An opening 152 of the holding slot 15 faces outward and downward. Two adjacent inner edges of each third connection surface 15c are perpendicular to each other. The two adjacent inner edges of each third connection surface 15c are connected to one tail end of the first connection surface 15a and one tail end of the second connection surface 15b, respectively, so that the two third connection surfaces 15c are connected to the first connection surface 15a and the second connection surface 15b along the vertical direction.

The holder 20 has a C-shaped frame 21 and two pivot pins 22. The frame 21 is the semicircle arc shape. The two pivot pins 22 are protruded towards each other from two ends of the frame 21. The two pivot pins 22 extend along the horizontal direction. The frame 21 is pivotally located in the holding slot 15 of the housing 10. The two pivot pins 22 are matched with the two blind holes 14. The two pivot pins 22 are assembled to the two blind holes 14. The two pivot pins 22 are connected to the two blind holes 14.

Referring to FIG. 1 to FIG. 5, the holder 20 is rotated to make that an angle between the holder 20 and the bottom surface of the housing 10 is ninety degrees, and rears of the two ends of the frame 21 of the holder 20 abut against the two third connection surfaces 15c, so that the holder 20 is secured, then the housing 10 and the secured holder 20 are positioned on the plane, at the moment, the housing 10 is inclined to the plane. Meanwhile, the wireless charging module 12 further includes a plurality of magnetic components 12a. The plurality of the magnetic components 12a are arranged around a periphery of the internal space 11. When the smart phone is positioned on the lid 13 of the wireless charger 100, the smart phone is magnetically attracted by the plurality of the magnetic components 12a of the wireless charger 100, so the smart phone is fixed on the lid 13 of the housing 10, and the smart phone is further combined with the wireless charger 100 to realize that the user uses the smart phone and the wireless charger 100 charges the smart phone at the same time.

Referring to FIG. 1 to FIG. 5 again, the inner wall 151 of the holding slot 15 further has at least one limiting block 15d. A middle of a lower portion of the inner wall 151 of the holding slot 15 protrudes frontward to form the at least one limiting block 15d. An outer portion of a middle of the first connection surface 15a protrudes outward to form the at least one limiting block 15d. The at least one limiting block 15d is disposed at the first connection surface 15a. The at least one limiting block 15d is located opposite to the second connection surface 15b. When the user has no need of using the holder 20 for supporting the housing 10, the frame 21 of the holder 20 is folded into the holding slot 15. When the frame 21 of the holder 20 is folded into the holding slot 15, the frame 21 of the holder 20 is secured in the holding slot 15, the at least one limiting block 15d blocks the frame 21 of the holder 20 in the holding slot 15, and the frame 21 of the holder 20 is fastened in the holding slot 15 by the at least one limiting block 15d. Specifically, the at least one limiting block 15d blocks a bottom of the frame 21 of the holder 20 to make the frame 21 of the holder 20 fastened in the holding slot 15.

When the holder 20 is rotated to make that the angle between the holder 20 and the bottom surface of the housing 10 is ninety degrees, and the rears of the two ends of the frame 21 of the holder 20 abut against rear surfaces of the two tail ends of the inner wall 151 of the holding slot 15, specifically, the rears of the two ends of the frame 21 of the holder 20 abut against the two third connection surfaces 15c, so that the holder 20 is secured, then the housing 10 and the secured holder 20 are positioned on the plane, and the housing 10 is inclined to the plane. When the holder 20 is folded into the holding slot 15, the holder 20 is located in the holding slot 15.

Referring to FIG. 1 to FIG. 5, a rear of the housing 10 defines a through-hole 16. The through-hole 16 is arranged opposite to the holding slot 15. The through-hole 16 penetrates through a rear of the peripheral surface 102 of the housing 10. A rear of the base portion 101 defines the through-hole 16. The through-hole 16 is connected between the internal space 11 and an external space. The wireless charging module 12 further includes a circular circuit board 12b, a cable 30 and a plug 40. The circuit board 12b is mounted in the internal space 11. The cable 30 is connected between the circuit board 12b and the plug 40. The cable 30 is soldered to the circuit board 12b. A front end of the cable 30 is connected to the wireless charging module 12. The front end of the cable 30 penetrates through the through-hole 16 of the housing 10 and is soldered to the circuit board 12b, and a rear end of the cable 30 is exposed outside of the housing 10 and is soldered to the plug 40. The plug 40 is connected to the rear end of the cable 30. The plug 40 is inserted into a power source (not shown). The plug 40 is connected with the power source to electrify the wireless charger 100.

As described above, the holder 20 of the wireless charger 100 is rotatable around the bottom surface of the housing 10, when the holder 20 is rotated to make that the angle between the holder 20 and the bottom surface of the housing 10 is ninety degrees, and the rears of the two ends of the frame 21 of the holder 20 abut against the two third connection surfaces 15c, so that the holder 20 is secured, then the housing 10 and the secured holder 20 are positioned on the plane, and the housing 10 is inclined to the plane, when the holder 20 is foldable, the holder 20 is folded into the holding slot 15, so that when the wireless charger 100 charges the smart phone, the user uses the smart phone conveniently. As a result, the user has a better viewing angle and a convenient operation.

What is claimed is:

1. A wireless charger, comprising:
a housing which is a circular plate shape, an inside of the housing having an internal space, a front of a lower portion of a peripheral surface of the housing being recessed inward to form a holding slot, the holding slot penetrating through a bottom surface of the housing, two sides of the housing defining two blind holes, the two blind holes being symmetrical to each other with respect to a center of the housing, the two blind holes penetrating through two sides of the peripheral surface of the housing and two outer portions of two tail ends of an inner wall of the holding slot, the two blind holes being disposed at two opposite ends of a diameter of the circular plate-shaped housing, the holding slot being disposed around an outer rim of the housing, the holding slot being connected with the two blind holes, the holding slot being a semicircle arc shape;
a wireless charging module assembled in the internal space; and
a holder placed in the holding slot, the holder being pivotally located in the housing, the holder being rotatable around the bottom surface of the housing, the holder having a C-shaped frame, and two pivot pins protruded towards each other from two ends of the frame, the two pivot pins being matched with the two blind holes, the two pivot pins being assembled to the two blind holes, the two pivot pins being connected to the two blind holes.

2. The wireless charger as claimed in claim 1, wherein a rear of the housing defining a through-hole, the through-hole is arranged opposite to the holding slot, the through-hole penetrates through a rear of the peripheral surface of the housing, the through-hole is connected between the internal space and an external space.

3. The wireless charger as claimed in claim 1, wherein the inner wall of the holding slot has a first connection surface, a second connection surface and two third connection surfaces, the first connection surface is disposed along a vertical direction, the first connection surface is connected to the bottom surface of the housing along the vertical direction, the first connection surface extends towards a top surface of the housing along the vertical direction, the second connection surface is disposed along a horizontal direction, the second connection surface is connected to a top edge of the first connection surface along the horizontal direction, the first connection surface is connected to an inner edge of the second connection surface along the vertical direction, the second connection surface extends towards the outer rim of the housing, the two third connection surfaces are disposed along the vertical direction, two adjacent inner edges of each third connection surface are perpendicular to each other, the two adjacent inner edges of each third connection surface are connected to one tail end of the first connection surface and one tail end of the second connection surface, respectively, so that the two third connection surfaces are connected to the first connection surface and the second connection surface along the vertical direction.

4. The wireless charger as claimed in claim 3, wherein the first connection surface is a semicircle shape.

5. The wireless charger as claimed in claim 3, wherein the second connection surface is another semicircle shape.

6. The wireless charger as claimed in claim 3, wherein the two third connection surfaces are rectangular shapes.

7. The wireless charger as claimed in claim 3, wherein the holding slot is a C shape, an opening of the holding slot faces outward and downward.

8. The wireless charger as claimed in claim 3, wherein the inner wall of the holding slot further has at least one limiting block, an outer portion of a middle of the first connection surface protrudes outward to form the at least one limiting block, the at least one limiting block is located opposite to the second connection surface, when the frame of the holder is folded into the holding slot, the frame of the holder is secured in the holding slot, the at least one limiting block blocks the frame of the holder in the holding slot.

9. The wireless charger as claimed in claim 1, wherein the wireless charging module further includes a circular circuit board, the circuit board is mounted in the internal space.

10. The wireless charger as claimed in claim 1, wherein the wireless charging module further includes a plurality of magnetic components, the plurality of the magnetic components are arranged around a periphery of the internal space.

11. A wireless charger, comprising:
a housing which is a circular plate shape, an inside of the housing having an internal space, a front of a lower portion of a peripheral surface of the housing being recessed inward to form a holding slot, the holding slot penetrating through a bottom surface of the housing, two sides of the housing defining two blind holes, the two blind holes being symmetrical to each other with respect to a center of the housing, the two blind holes penetrating through two sides of the peripheral surface of the housing and two outer portions of two tail ends of an inner wall of the holding slot, the holding slot being connected with the two blind holes, the holding slot being a semicircle arc shape;
a wireless charging module assembled in the internal space;
a plurality of magnetic components arranged around a periphery of the internal space; and
a holder being pivotally mounted in the holding slot of the housing, the holder being rotatable around the bottom surface of the housing, the holder being foldable, the holder having a frame, and two pivot pins protruded towards each other from two ends of the frame, the frame being the semicircle arc shape, the frame being pivotally located in the holding slot of the housing, the two pivot pins being assembled to the two blind holes;
wherein when the holder is rotated to make that an angle between the holder and the bottom surface of the housing is ninety degrees, and rears of the two ends of the frame of the holder abut against rear surfaces of the two tail ends of the inner wall of the holding slot, so that the holder is secured, then the housing and the secured holder are positioned on a plane, and the housing is inclined to the plane, when the holder is folded into the holding slot, the holder is located in the holding slot.

12. A wireless charger, comprising:
a housing which is a circular plate shape, an inside of the housing having an internal space, the internal space penetrating through a top of the housing, a front of a lower portion of a peripheral surface of the housing being recessed inward to form a holding slot, the holding slot penetrating through a bottom surface of the housing, two sides of the housing defining two blind holes, the two blind holes being symmetrical to each other with respect to a center of the housing, the two blind holes penetrating through two sides of the peripheral surface of the housing and two outer portions of two tail ends of an inner wall of the holding slot, the holding slot being connected with the two blind holes, the holding slot being a semicircle arc shape, a middle of a lower portion of the inner wall of the holding slot protruding frontward to form at least one limiting block;
a lid covered to the top of the housing to enclose the internal space between the housing and the lid;
a wireless charging module assembled in the internal space;
a plurality of magnetic components arranged around a periphery of the internal space;
a holder being pivotally mounted in the holding slot of the housing, the holder being rotatable around the bottom surface of the housing, the holder being foldable, the holder having a frame, and two pivot pins protruded towards each other from two ends of the frame, the frame being the semicircle arc shape, the frame being pivotally located in the holding slot of the housing, the two pivot pins being assembled to the two blind holes;
a cable, a front end of the cable being connected to the wireless charging module; and
a plug connected to a rear end of the cable;
wherein when the holder is rotated to make that an angle between the holder and the bottom surface of the housing is ninety degrees, and rears of the two ends of the frame of the holder abut against rear surfaces of the two tail ends of the inner wall of the holding slot, so that the holder is secured, then the housing and the secured holder are positioned on a plane, and the housing is inclined to the plane; and
wherein when the holder is folded into the holding slot, the at least one limiting block blocks a bottom of the frame of the holder to make the frame of the holder fastened in the holding slot.
